(19) United States
(12) Patent Application Publication
(10) Pub. No.: US 2025/0200453 A1
(43) Pub. Date: Jun. 19, 2025

(54) METHOD FOR CONFIGURATION ANALYSIS, APPARATUS, ELECTRONIC DEVICE, AND READABLE STORAGE MEDIUM

(71) Applicant: Beijing Volcano Engine Technology Co., Ltd., Haidian District (CN)

(72) Inventors: Kang Han, Beijing (CN); Yinmeng Zhang, Beijing (CN); Lu Li, Beijing (CN); Danchi Fan, Beijing (CN)

(21) Appl. No.: 18/981,060

(22) Filed: Dec. 13, 2024

(30) Foreign Application Priority Data
Dec. 14, 2023 (CN) 202311725427.3

(51) Int. Cl. G06Q 10/063

(52) U.S. Cl. CPC G06Q 10/063

(57) ABSTRACT

The disclosure relates to a method for configuration analysis, an apparatus, an electronic device, and a readable storage medium. The method includes: presenting an event analysis interface, where the event analysis interface includes a to-be-configured indicator entry, the to-be-configured indicator entry being configured to configure an object to be analyzed, and the to-be-configured indicator entry includes an event setting item and a calculation condition setting item; presenting, in response to a target trigger operation, a configuration recommendation panel corresponding to the to-be-configured indicator entry; and presenting, in the to-be-configured indicator entry, target configuration information corresponding to a target recommendation configuration item in response to a trigger operation on the target recommendation configuration item in the plurality of recommendation configuration items.

### CROSS-REFERENCE

This application claims priority to Chinese Patent Application No. 202311725427.3 filed on Dec. 14, 2023, and entitled “METHOD FOR CONFIGURATION ANALYSIS, APPARATUS, ELECTRONIC DEVICE, AND READABLE STORAGE MEDIUM ”.

### FIELD

The present disclosure relates to the field of computer technologies, and in particular, to a method for configuration analysis, an apparatus, an electronic device, and a computer-readable storage medium.

### BACKGROUND

At present, in the operation management processes of many operation platforms, data analysis tools are needed for user analysis. Data analysis tools may provide digital analysis for enterprises, optimize user experience of a digital touchpoints, support refined user operations, discover key growth opportunities for businesses, and improve enterprise benefits.

Event analysis, as one of the most important analysis methods for data analysis, can help us study the value impact of an event on an enterprise caused by the occurrence of it. Generally, an event analysis includes three steps: configuring an analysis object, configuring an analysis method, and checking an analysis result. The step of configuring the analysis object has a high threshold for understanding and learning, and requires a user to have certain capabilities for configuration analysis.

However, in a real business environment, most users are business operators with data weak analysis capabilities and less experiences, and cannot quickly and accurately configure the

### SUMMARY

To solve the above technical problems or at least partially solve the above technical problems, the present disclosure provides a method for configuration analysis an apparatus, an electronic device, a storage medium, and a program product.

According to a first aspect of embodiments of the present disclosure, there is provided a method for configuration analysis, the method includes: presenting an event analysis interface, where the event analysis interface includes a to-be-configured indicator entry, the to-be-configured indicator entry being configured to configure an object to be analyzed, and the to-be-configured indicator entry includes an event setting item and a calculation condition setting item; where the event setting item is configured to set an event of the object to be analyzed, and the calculation condition setting item is configured to set a calculation condition of the object to be analyzed, the calculation condition including a calculation manner, or the calculation condition including the calculation manner and at least one filtering condition; presenting, in response to a target trigger operation, a configuration recommendation panel corresponding to the to-be-configured indicator entry, where a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and presenting, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

In some embodiments of the present disclosure, the plurality of recommendation configuration items include at least one of the following: at least one historical event configuration item and at least one historical indicator configuration item; the configuration recommendation panel further includes an event tag and an indicator tag, and in response that the event tag is in a selected state, the configuration recommendation panel is further configured to present a plurality of historical event configuration items, where the plurality of recommendation configuration items are ranked before the plurality of historical event configuration items, and the at least one historical event configuration item is a part of the plurality of historical event configuration items, where each historical event configuration item is used to indicate event configuration information of a historical analysis object; and in response that the indicator tag is in a selected state, the configuration recommendation panel is further configured to present a plurality of historical indicator configuration items, where the plurality of recommendation configuration items are ranked before the plurality of historical indicator configuration items, and the at least one historical indicator configuration item is a part of the plurality of historical indicator configuration items, where each historical indicator configuration item is used to indicate indicator configuration information of a historical analysis object; where the historical configuration item set includes the plurality of historical event configuration items and the plurality of historical indicator configuration items.

In some embodiments of the present disclosure, the configuration recommendation panel further includes a source identification corresponding to each recommendation configuration item; in response that the recommendation configuration item is a historical event configuration item, the source identification corresponding to the recommendation configuration item is an event identification, and the event identification is used to indicate that the recommendation configuration item is from an event library; or in response that the recommendation configuration item is a historical indicator configuration item, the source identification of the recommendation configuration item includes any one of the following: a local indicator identification, a from-chart identification, and a third-party indicator identification; where the local indicator identification is used to indicate that the recommendation configuration item is from a local indicator library, the from-chart identification is used to indicate that the recommendation configuration item is from chart information in an analysis result corresponding to a historical analysis object, and the third-party indicator identification is used to indicate that the recommendation configuration item is from an indicator library of a third-party data management application.

In some embodiments of the present disclosure, after presenting, in response to the trigger operation on the to-be-configured indicator entry, the configuration recommendation panel, the method further includes: presenting, in response to the trigger operation on the target recommendation configuration item, a configuration details panel corresponding to the target recommendation configuration item, where configuration information of a target analysis object indicated by the target recommendation configuration item is presented in the configuration details panel; in response that the target recommendation configuration item is a historical event configuration item, the configuration information of the target analysis object includes an event identification, event description information, and event data quality information of an event of the target analysis object; in response that the target recommendation configuration item is a historical indicator configuration item, and a source of the target recommendation configuration item is a local indicator library or an indicator library of a third-party data management application, the configuration information of the target analysis object includes an indicator meaning, indicator details information, and indicator data quality information of an indicator of the target analysis object; or in a case that the target recommendation configuration item is a historical indicator configuration item, and a source of the target recommendation configuration item is chart information in an analysis result corresponding to a corresponding historical analysis object, the configuration information of the target analysis object includes indicator details information of an indicator of the target analysis object, a chart identification of a target chart to which the indicator belongs, and a dashboard identification of a target dashboard to which the target chart belongs, where the target dashboard is used to present a chart in an analysis result corresponding to at least one historical analysis object.

In some embodiments of the present disclosure, in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate; and/or a configurator identification corresponding to the target recommendation configuration item is further presented in the configuration details panel, and the configurator identification is used to call a target instant messaging application and create a chat window between the current user and a user indicated by the configurator identification; and/or in response that the target recommendation configuration item is a historical indicator configuration item, and a source of the target recommendation configuration item is chart information in an analysis result corresponding to a corresponding historical analysis object, a name of the target recommendation configuration item is generated based on the chart identification and the indicator details information.

In some embodiments of the present disclosure, the method further includes: in response that a target event is presented in the event setting item and no calculation condition is presented in the calculation condition setting item, presenting an indicator recommendation panel in response to a trigger operation on the to-be-configured indicator entry, where the indicator recommendation panel includes a plurality of recommendation indicator items, and each recommendation indicator item is used to indicate an indicator including the target event; and presenting, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

In some embodiments of the present disclosure, the indicator recommendation panel further presents a source identification of each recommendation indicator item, and the source identification of the recommendation indicator item includes any one of the following: a local indicator identification, a from-chart identification, and a third-party indicator identification; where the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application;

and/or the plurality of recommendation indicator items are arranged in a descending order according to corresponding recommendation indices, where the recommendation index of the recommendation indicator is obtained through comprehensive evaluation based on historical query information of a corresponding recommendation indicator, and the historical query information includes at least one of the following: a number of historical queries, a number of people conducting historical queries and a historical query record.

In some embodiments of the present disclosure, the method further includes: updating a target calculation condition in response to an edit operation on the target calculation condition in response that the target event is presented in the event setting item and the target calculation condition is presented in the calculation condition setting item.

In some embodiments of the present disclosure, the target trigger operation includes a first trigger operation on the to-be-configured indicator entry and a search operation on a search control, and presenting, in response to the target trigger operation, the configuration recommendation panel corresponding to the to-be-configured indicator entry includes: presenting, in response to the first trigger operation, the configuration recommendation panel including the search control; and presenting, in response to the search operation, the plurality of recommendation configuration items in the configuration recommendation panel; where the plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

In some embodiments of the present disclosure, configuration information of an analysis object indicated by each search configuration item includes the search keyword, and/or configuration information of an analysis object indicated by each search configuration item includes information representing a generalized meaning of the search keyword.

According to a second aspect of embodiments of the present disclosure, there is provided an apparatus for configuration analysis, the apparatus includes: a presenting module, configured to present an event analysis interface, where the event analysis interface includes a to-be-configured indicator entry, the to-be-configured indicator entry being configured to configure an object to be analyzed, and the to-be-configured indicator entry includes an event setting item and a calculation condition setting item; where the event setting item is configured to set an event of the object to be analyzed, and the calculation condition setting item is configured to set a calculation condition of the object to be analyzed, the calculation condition including a calculation manner, or the calculation condition including the calculation manner and at least one filtering condition; present, in response to a target trigger operation, a configuration recommendation panel corresponding to the to-be-configured indicator entry, where a plurality of recommendation configuration items are presented in the configuration recommendation panel, and the plurality of recommendation configuration items being historical configuration items that have a highest matching probability with a current user in a historical configuration item set, and each historical configuration item is used to indicate configuration information of a historical analysis object; and present, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

In some embodiments of the present disclosure, the plurality of recommendation configuration items include at least one of the following: at least one historical event configuration item and at least one historical indicator configuration item; the configuration recommendation panel further includes an event tag and an indicator tag, and in response that the event tag is in a selected state, the configuration recommendation panel is further configured to present a plurality of historical event configuration items, where the plurality of recommendation configuration items are ranked before the plurality of historical event configuration items, and the at least one historical event configuration item is a part of the plurality of historical event configuration items, where each historical event configuration item is used to indicate event configuration information of a historical analysis object; and in response that the indicator tag is in a selected state, the configuration recommendation panel is further configured to present a plurality of historical indicator configuration items, where the plurality of recommendation configuration items are ranked before the plurality of historical indicator configuration items, and the at least one historical indicator configuration item is a part of the plurality of historical indicator configuration items, where each historical indicator configuration item is used to indicate indicator configuration information of a historical analysis object; where the historical configuration item set includes the plurality of historical event configuration items and the plurality of historical indicator configuration items.

In some embodiments of the present disclosure, the configuration recommendation panel further includes a source identification corresponding to each recommendation configuration item; in response that the recommendation configuration item is a historical event configuration item, the source identification corresponding to the recommendation configuration item is an event identification, and the event identification is used to indicate that the recommendation configuration item is from an event library; or in response that the recommendation configuration item is a historical indicator configuration item, the source identification of the recommendation configuration item includes any one of the following: a local indicator identification, a from-chart identification, and a third-party indicator identification; where the local indicator identification is used to indicate that the recommendation configuration item is from a local indicator library, the from-chart identification is used to indicate that the recommendation configuration item is from chart information in an analysis result corresponding to a historical analysis object, and the third-party indicator identification is used to indicate that the recommendation configuration item is from an indicator library of a third-party data management application.

In some embodiments of the present disclosure, the presenting module is further configured to: after presenting, in response to the trigger operation on the to-be-configured indicator entry, present, in response to the trigger operation on the target recommendation configuration item, a configuration details panel corresponding to the target recommendation configuration item, where configuration information of a target analysis object indicated by the target recommendation configuration item is presented in the configuration details panel; in response that the target recommendation configuration item is a historical indicator configuration item, and a source of the target recommendation configuration item is a local indicator library or an indicator library of a third-party data management application, the configuration information of the target analysis object includes an indicator meaning, indicator details information, and indicator data quality information of an indicator of the target analysis object; in response that the target recommendation configuration item is a historical indicator configuration item, and a source of the target recommendation configuration item is chart information in an analysis result corresponding to a corresponding historical analysis object, the configuration information of the target analysis object includes indicator details information of an indicator of the target analysis object, a chart identification of a target chart to which the indicator belongs, and a dashboard identification of a target dashboard to which the target chart belongs, where the target dashboard is used to present a chart in an analysis result corresponding to at least one historical analysis object.

In some embodiments of the present disclosure, in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate; and/or a configurator identification corresponding to the target recommendation configuration item is further presented in the configuration details panel, and the configurator identification is used to call a target instant messaging application and create a chat window between the current user and a user indicated by the configurator identification; and/or in response that the target recommendation configuration item is a historical indicator configuration item, and a source of the target recommendation configuration item is chart information in an analysis result corresponding to a corresponding historical analysis object, a name of the target recommendation configuration item is generated based on the chart identification and the indicator details information.

In some embodiments of the present disclosure, the presenting module is further configured to: in response that a target event is presented in the event setting item and no calculation condition is presented in the calculation condition setting item, present an indicator recommendation panel in response to a trigger operation on the to-be-configured indicator entry, where the indicator recommendation panel includes a plurality of recommendation indicator items, and each recommendation indicator item is used to indicate an indicator including the target event; and present, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

In some embodiments of the present disclosure, the indicator recommendation panel further presents a source identification of each recommendation indicator item, and the source identification of the recommendation indicator item includes any one of the following: a local indicator identification, a from-chart identification, and a third-party indicator identification; where the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application; and/or the plurality of recommendation indicator items are arranged in a descending order according to corresponding recommendation indices, where the recommendation index of the recommendation indicator is obtained through comprehensive evaluation based on historical query information of a corresponding recommendation indicator, and the historical query information includes at least one of the following: a number of historical queries, a number of people conducting historical queries and a historical query record.

In some embodiments of the present disclosure, the apparatus further includes: an update module, configured to update a target calculation condition in response to an edit operation on the target calculation condition in response that the target event is presented in the event setting item and the target calculation condition is presented in the calculation condition setting item.

In some embodiments of the present disclosure, the target trigger operation includes a first trigger operation on the to-be-configured indicator entry and a search operation on a search control, and the presenting module is specifically configured to: present, in response to the first trigger operation, the configuration recommendation panel including the search control; and present, in response to the search operation, the plurality of recommendation configuration items in the configuration recommendation panel; where the plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

In some embodiments of the present disclosure, configuration information of an analysis object indicated by each search configuration item includes the search keyword, and/or configuration information of an analysis object indicated by each search configuration item includes information representing a generalized meaning of the search keyword.

According to a third aspect of embodiments of the present disclosure, there is provided an electronic device, the electronic device includes: a memory and a processor, where the memory is configured to store a computer program; and the processor is configured to execute, when the computer program is called, the method for configuration analysis according to the first aspect.

According to a fourth aspect of embodiments of the present disclosure, there is provided a computer-readable storage medium having stored thereon a computer program which, when executed by a processor, implements the method for configuration analysis according to the first aspect.

According to a fifth aspect of embodiments of the present disclosure, there is provided a computer program product, where the computer program product includes a computer program, and the computer program, when executed by a processor, implements the method for configuration analysis according to the first aspect.

According to a sixth aspect of embodiments of the present disclosure, there is provided a chip, the chip including a processor and a communication interface, the communication interface being coupled to the processor, the processor being configured to run program instructions to implement the method configuration analysis according to the first aspect.

Compared with the prior art, the technical solution provided in embodiments of the present disclosure has the following advantages: In embodiments of the present disclosure, an event analysis interface is presented, where the event analysis interface includes a to-be-configured indicator entry, the to-be-configured indicator entry being configured to configure an object to be analyzed, and the to-be-configured indicator entry includes an event setting item and a calculation condition setting item; where the event setting item is configured to set an event of the object to be analyzed, and the calculation condition setting item is configured to set a calculation condition of the object to be analyzed, the calculation condition including a calculation manner, or the calculation condition including the calculation manner and at least one filtering condition; in response to a target trigger operation, a configuration recommendation panel corresponding to the to-be-configured indicator entry is presented, where a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and in the to-be-configured indicator entry, target configuration information corresponding to a target recommendation configuration item is presented in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result. In this way, when the event analysis interface is presented, the plurality of recommendation configuration items may be presented in response to the target trigger operation. The plurality of recommendation configuration items are historical configuration items that have a highest matching probability with the current user in the historical configuration item set, so that the user may quickly and accurately determine the target recommendation configuration item needed by the user from the plurality of recommendation configuration items, and the to-be-configured indicator entry may be configured based on the target configuration information corresponding to the target recommendation configuration item, thereby the user may quickly and accurately complete the configuration of the object to be analyzed. The efficiency of configuring the analysis object is improved, and then the corresponding buried point data is obtained from the database corresponding to the object to be analyzed based on the target configuration information, and the event analysis is performed on the object to be analyzed to obtain the analysis result, which may improve the accuracy of the analysis result.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

In order to more clearly illustrate the technical solutions in the embodiments of the present disclosure or in the prior art, the drawings used in the description of the embodiments or the prior art will be briefly described below. It is apparent that the drawings in the following description show merely some embodiments of the present disclosure, and a person of ordinary skill in the art may still derive other drawings from these drawings without creative efforts.

FIG. 1 is a schematic flowchart of a method for configuration analysis according to an embodiment of the present disclosure;

FIG. 2 is a schematic diagram of an interface of a method for configuration analysis according to an embodiment of the present disclosure;

FIG. 3(a) is a second schematic diagram of an interface of a method for configuration analysis according to an embodiment of the present disclosure;

FIG. 3(b) is a third schematic diagram of an interface of a method for configuration analysis according to an embodiment of the present disclosure;

FIG. 3(c) is a fourth schematic diagram of an interface of a method for configuration analysis according to an embodiment of the present disclosure;

FIG. 4 is a fifth schematic diagram of an interface of a method for configuration analysis according to an embodiment of the present disclosure;

FIG. 5 is a sixth schematic diagram of an interface of a method for configuration analysis according to an embodiment of the present disclosure;

FIG. 6 is a block diagram of a structure of an apparatus for configuration analysis according to an embodiment of the present disclosure; and

FIG. 7 is a block diagram of a structure of an electronic device according to an embodiment of the present disclosure.

### DETAILED DESCRIPTION

In order to more clearly understand the above objectives, features, and advantages of the present disclosure, the solutions of the present disclosure are further described below. It should be noted that the embodiments of the present disclosure and the features of the embodiments may be combined with each other without conflict.

Many specific details are set forth in the following description to fully understand the present disclosure. However, the present disclosure may also be implemented in other manners than those described herein. Obviously, the embodiments described in the specification are only some embodiments of the present disclosure, but not all of the embodiments.

The terms “first”, “second”, and the like in the specification and claims of the present disclosure are used to distinguish between similar objects, but are not used to describe a specific order or sequence. It should be understood that the data termed in such a way is interchangeable in proper circumstances so that the embodiments of the present disclosure may be implemented in orders except for the order illustrated or described herein. Moreover, the objects distinguished by “first”, “second”, and the like are usually a class, and do not limit the number of the objects. For example, the first object may be one or more than one. In addition, “and/or” in the specification and claims indicates at least one of the connected objects. The character “/” generally indicates an “or” relationship between the associated objects.

At present, when a user just starts an event analysis, the user first needs to configure an analysis object in the to-be-configured indicator entry. Currently, some recommendation functions present a large number of (possibly hundreds or thousands, or even more) historical configuration items for the user, so the user needs to select one historical configuration item from the large number of historical configuration items to configure the object to be analyzed; some recommendation functions classify the large number of historical configuration items. If the classification is relatively clear and the category of the object to be analyzed is relatively clear to the user, the user may select to perform an initial screening on the historical configuration items based on the classification, and then select a target historical configuration item from a result from the initial screening to configure the to-be-configured indicator entry (the object to be analyzed). However, generally, even if the large number of historical configuration items are classified, the classification is often coarse-grained, and in more cases, the large number of historical configuration items are not classified.

At present, historical indicator configuration items in a local indicator library are created by respective users in the projects on a daily basis, which may be saved into the local indicator library without accuracy verification, and the reliability is difficult to guarantee. Other users cannot predict in advance which historical indicator configuration items are already in the local indicator library. Therefore, the reuse rate of the historical indicator configuration items in the local indicator library has always been relatively low.

In this way, in a real business environment, most users are business operators, which are with weak data analysis capabilities and less experiences, and cannot quickly and accurately configure an analysis object, resulting in the low efficiency of configuring the analysis object.

The electronic device in the embodiments of the present disclosure may be a mobile electronic device or a non-mobile electronic device. The mobile electronic device may be a mobile phone, a tablet computer, a notebook computer, a palmtop computer, an in-vehicle electronic device, a wearable device, an ultra-mobile personal computer (UMPC), a netbook, or a personal digital assistant (PDA), etc. The non-mobile electronic device may be a personal computer (PC), a television (TV), a teller machine, or a self-service machine, etc. This is not specifically limited in the embodiments of the present disclosure.

An execution body of the method for configuration analysis provided in the embodiments of the present disclosure may be the foregoing electronic device (including the mobile electronic device and the non-mobile electronic device), or may be a function module and/or a function entity capable of implementing the method for configuration analysis in the electronic device. The specific implementation may be determined according to actual use requirements, and is not limited in the embodiments of the present disclosure.

The method for configuration analysis provided in the embodiments of the present disclosure is described in detail below with reference to the accompanying drawings and through specific embodiments and application scenarios thereof.

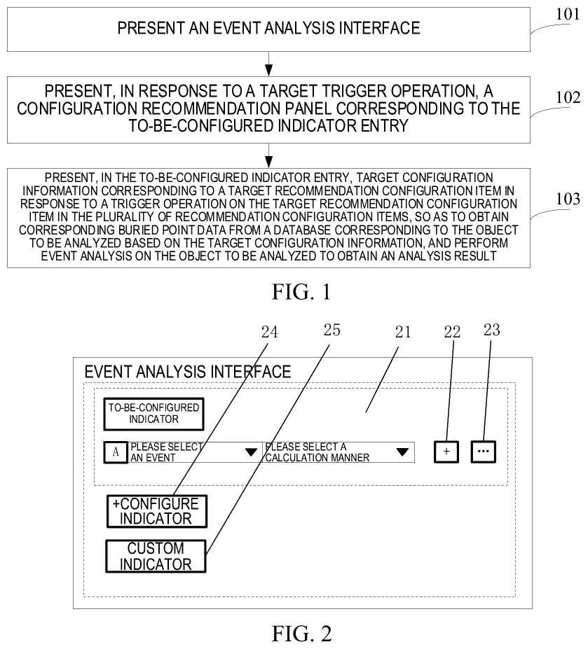

As shown in FIG. 1, an embodiment of the present disclosure provides a method for configuration analysis, the method may include the following steps 101 to 103.
101: Present an event analysis interface.

The event analysis interface includes a to-be-configured indicator entry, the to-be-configured indicator entry being configured to configure an object to be analyzed, and the to-be-configured indicator entry includes an event setting item and a calculation condition setting item; where the event setting item is configured to set an event of the object to be analyzed, and the calculation condition setting item is configured to set a calculation condition of the object to be analyzed, the calculation condition including a calculation manner, or the calculation condition including the calculation manner and at least one filtering condition.

In response that the calculation condition setting item includes only a calculation manner setting item, the calculation condition setting item is configured to set a calculation manner of the object to be analyzed; or when the calculation condition setting item includes the calculation manner setting item and at least one filtering condition setting item, the calculation condition setting item is configured to set the calculation manner and at least one filtering condition of the object to be analyzed.

In embodiments of the present disclosure, the event analysis interface may further include another to-be-configured indicator entry, a configured indicator entry, a new indicator entry control for generating the to-be-configured indicator entry, and a user-defined indicator entry control, which may be specifically determined according to an actual situation and is not limited herein.
102: Present, in response to a target trigger operation, a configuration recommendation panel corresponding to the to-be-configured indicator entry.

A plurality of recommendation configuration items is presented in the configuration recommendation panel, the plurality of recommendation configuration items being historical configuration items that have a highest matching probability with a current user in a historical configuration item set, and each historical configuration item is used to indicate configuration information of a historical analysis object.

Each recommendation configuration item is used to indicate configuration information of a historical analysis object. A historical analysis object is used to indicate an object for which corresponding data is obtained from a corresponding database to perform event analysis based on configuration information of the historical analysis object before a current moment.

The configuration information of a historical analysis object includes an event, or an event and a calculation condition, where the calculation condition includes a calculation manner, or the calculation manner and at least one filtering condition.

The matching probability is determined based on the query on a historical event configuration item, a historical indicator configuration item, and a chart within a predetermined duration by a current user and other users in a same project.

In some embodiments of the present disclosure, the plurality of recommendation configuration items may be arranged in a descending order of corresponding matching probabilities. The number of the plurality of recommendation configuration items may be fixed (for example, a predetermined number of historical configuration items with the highest matching probabilities are selected from the historical configuration items in the historical configuration item set as the plurality of recommendation configuration items), or may be determined in real time based on a matching probability threshold (for example, a plurality of historical configuration items with matching probabilities greater than or equal to the matching probability threshold are selected from the historical configuration items in the historical configuration item set as the plurality of recommendation configuration items), which may be specifically determined according to an actual situation, and is not limited herein.

In embodiments of the present disclosure, in a real business scenario, events corresponding to an event analysis in a period of time are relatively concentrated and repetitive. Therefore, an object frequently analyzed by the current user and another user (colleague) in the same project in a recent period of time has a high probability of being an object that the user wants to analyze this time. Therefore, the matching probability is set to be determined based on query on a historical event configuration item, a historical indicator configuration item, and a chart within a predetermined duration by a current user and another user in the same project, so that historical configuration items matched with the user may be more accurately recommended to the user. In this way, the user may select a required historical configuration item from the historical configuration items, and configure the object to be analyzed based on configuration information corresponding to the historical configuration item, that is, configure the to-be-configured indicator entry. The predetermined duration may be determined according to an actual situation, which is not limited herein.

For example, as shown in FIG. 2, an area indicated by reference numeral “21” is an area where the to-be-configured indicator entry is located, a control indicated by reference numeral “22” is a filtering condition addition control, a control indicated by reference numeral “23” is a presenting more control, a control indicated by reference numeral “24” is a new configuration indicator entry control, and a control indicated by reference numeral “25” is a user-defined indicator entry.
103: Present, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

The target recommendation configuration item is any one of the plurality of recommendation configuration items.

It may be understood that the user does not need to select a required historical configuration item from a large number of disordered and chaotic historical configuration items, but may directly select the required historical configuration item from the plurality of recommendation configuration items to configure the to-be-configured indicator entry, so as to determine the object to be analyzed.

In embodiments of the present disclosure, in response that the event analysis interface is presented, the plurality of recommendation configuration items may be presented in response to the target trigger operation. The plurality of recommendation configuration items are historical configuration items that have a highest matching probability with the current user in the historical configuration item set, so that the user may quickly and accurately determine the target recommendation configuration item required by the user from the plurality of recommendation configuration items, and the to-be-configured indicator entry may be configured based on the target configuration information corresponding to the target recommendation configuration item, thereby the user may quickly and accurately complete the configuration of the object to be analyzed, improving the efficiency of configuring the analysis object, and then the corresponding buried point data is obtained from the database corresponding to the object to be analyzed based on the target configuration information, and the event analysis is performed on the object to be analyzed to obtain the analysis result, which may improve the accuracy of the analysis result.

In embodiments of the present disclosure, on the basis of not changing original configuration parameters of the user while interacting, adding a plurality of recommendation configuration items as a recommendation option may help the user select a configuration option for configuring the analysis object from a large number of disordered configuration options more quickly and accurately, thereby enabling accurate and quick implementation of the configuration of the analysis object.

In some embodiments of the present disclosure, the target trigger operation includes only a trigger operation on the to-be-configured indicator entry, and does not include another operation, and step 102 may specifically be presenting a configuration recommendation panel including a plurality of recommendation configuration items (hereinafter referred to as an initial recommendation scenario, and the plurality of recommendation configuration items are a plurality of initial recommendation configuration items) in response to the trigger operation on the to-be-configured indicator entry (the target trigger operation) without another operation; or the target trigger operation may include a first trigger operation on the to-be-configured indicator entry and a search operation on a search control, and step 102 may specifically be first presenting, in response to the first trigger operation on the to-be-configured indicator entry, the configuration recommendation panel including the search control, and then presenting, in response to the search operation on the search control, the plurality of recommendation configuration items in the configuration recommendation panel (hereinafter referred to as a search recommendation scenario, and the plurality of recommendation configuration items are a plurality of search recommendation configuration items); which may be specifically determined according to an actual situation, and is not limited herein.

In some embodiments of the present disclosure, the target trigger operation includes the first trigger operation on the to-be-configured indicator entry and the search operation on the search control, and step 102 may be specifically implemented through the following steps 102a and 102b.
102a: Present, in response to the first trigger operation, the configuration recommendation panel including the search control.
102b: Present, in response to the search operation, the plurality of recommendation configuration items in the configuration recommendation panel.

The plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

It may be understood that the plurality of recommendation configuration items are historical configuration items that are matched based on a search.

In embodiments of the present disclosure, in the search recommendation scenario, the plurality of search recommendation configuration items that have the highest matching probability with the current user in the plurality of search configuration items are presented for the user, so that historical configuration items that meet the requirements of the user may be more accurately recommended to the user.

In some embodiments of the present disclosure, configuration information of an analysis object indicated by each search configuration item includes the search keyword, and/or information representing a generalized meaning of the search keyword. In this way, the user may obtain a generalized meaning with a natural language corresponding to the search keyword in response that the user cannot remember the object to be analyzed, and then obtain a corresponding historical configuration item that matches the search keyword and/or a corresponding historical configuration item that matches the generalized meaning of the search keyword, thereby reducing the threshold of the user for parameters configuration.

The information representing a generalized meaning of the search keyword may refer to a word or sentence that has the same or similar meaning as the search keyword, and may be specifically determined according to an actual situation, which is not limited herein.

In some embodiments of the present disclosure, the configuration recommendation panel in step 102a may further present a plurality of configuration items in addition to the search control, and the plurality of configuration items are the same as the plurality of initial recommendation configuration items, and the plurality of search recommendation configuration items presented in step 102b are different from the plurality of initial recommendation configuration items; which may be specifically determined according to an actual situation, and is not limited herein.

If the user cannot quickly find a recommendation configuration item corresponding to the object to be analyzed from the plurality of initial recommendation configuration items presented in the recommendation configuration panel in the initial recommendation scenario, and cannot quickly find a historical event configuration item corresponding to the to-be-shared object from the plurality of historical event configuration items presented in response that the event tag is in the selected state (or cannot quickly find a historical indicator configuration item corresponding to the object to be analyzed from the plurality of historical indicator configuration items presented in response that the indicator tag is in the selected state), the search recommendation scenario may be used. A plurality of search recommendation configuration items is presented in the recommendation configuration panel by triggering a search operation on the search control, and then a recommendation configuration item corresponding to the object to be analyzed is found from the plurality of search recommendation configuration items.

It should be noted that the following description of the plurality of recommendation configuration items is applicable to the plurality of initial recommendation configuration items and the plurality of search recommendation configuration items.

In some embodiments of the present disclosure, In some embodiments of the present disclosure, the plurality of recommendation configuration items include at least one of the following: at least one historical event configuration item and at least one historical indicator configuration item; the configuration recommendation panel further includes an event tag and an indicator tag, and in response that the event tag is in a selected state, the configuration recommendation panel is further configured to present a plurality of historical event configuration items, where the plurality of recommendation configuration items are ranked before the plurality of historical event configuration items, and the at least one historical event configuration item is a part of the plurality of historical event configuration items, where each historical event configuration item is used to indicate event configuration information of a historical analysis object; and in response that the indicator tag is in a selected state, the configuration recommendation panel is further configured to present a plurality of historical indicator configuration items, where the plurality of recommendation configuration items are ranked before the plurality of historical indicator configuration items, and the at least one historical indicator configuration item is a part of the plurality of historical indicator configuration items, where each historical indicator configuration item is used to indicate indicator configuration information of a historical analysis object; where the historical configuration item set includes the plurality of historical event configuration items and the plurality of historical indicator configuration items.

In embodiments of the present disclosure, the configuration recommendation panel is divided into the plurality of historical event configuration items indicated by the event tag and the plurality of historical indicator configuration items indicated by the indicator tag.

In some embodiments of the present disclosure, in response that the event tag in the configuration recommendation panel is in the selected state, each recommendation configuration item is a historical event configuration item matched for the user from the plurality of historical event configuration items; or in response that the indicator tag in the configuration recommendation panel is in the selected state, each recommendation configuration item is a historical indicator configuration item matched for the user from the plurality of historical indicator configuration items.

In some embodiments of the present disclosure, each recommendation configuration item is a historical event configuration item matched for the user from the plurality of historical event configuration items or a historical indicator configuration item matched for the user from the plurality of historical indicator configuration items. In other words, in embodiments of the present disclosure, in response that the plurality of recommendation configuration items is determined, a historical configuration item that has a highest matching probability with the current user is matched from the plurality of historical event configuration items and the plurality of historical indicator configuration items. In other words, the plurality of recommendation configuration items presented in response that the event tag in the configuration recommendation panel is in the selected state are the same as the plurality of recommendation configuration items presented in response that the indicator tag in the configuration recommendation panel is in the selected state. In this way, the user does not need to determine first whether the object to be analyzed to be configured is classified under the event tag or the indicator tag in response to configuring the analysis object, which may improve the efficiency of the user in quickly and accurately selecting a required target recommendation configuration item from the plurality of recommendation configuration items and improve the user experience.

In embodiments of the present disclosure, the fact that a historical indicator configuration item or a historical event configuration item is frequently used in a recent period of time indicates that the historical indicator configuration item or the historical event configuration item is highly reliable. Therefore, taking a historical indicator configuration item or a historical event configuration item frequently used by all users (the current user and another user (colleague)) in a project in a recent period of time as a recommendation configuration item greatly improves the adoption rate and the reuse rate of the recommendation configuration item, and also eliminates the user's concern about the reliability of a historical indicator configuration item or a historical event configuration item created by another person.

In some embodiments of the present disclosure, the configuration recommendation panel further includes a source identification corresponding to each recommendation configuration item, and the source identification is used to indicate a source of a corresponding recommendation configuration item. In this way, the user may know the source of each recommendation configuration item.

In some embodiments of the present disclosure, in response that a recommendation configuration item is a historical event configuration item, a source identification corresponding to the recommendation configuration item is an event identification, and the event identification is used to indicate that the recommendation configuration item is from an event library. In this way, in response that the plurality of recommendation configuration items are historical configuration items that have a highest matching probability with the current user in the plurality of historical event configuration items and the plurality of historical indicator configuration items, it may be clearly learned that the recommendation configuration item is from the event library.

In some embodiments of the present disclosure, in response that a recommendation configuration item is a historical indicator configuration item, a source identification of the recommendation configuration item includes any one of the following: a local indicator identification, a from-chart identification, and a third-party indicator identification; where the local indicator identification is used to indicate that the recommendation configuration item is from a local indicator library, the from-chart identification is used to indicate that the recommendation configuration item is from-chart information in an analysis result corresponding to a historical analysis object (hereinafter referred to as from-chart for short), and the third-party indicator identification is used to indicate that the recommendation configuration item is from an indicator library of a third-party data management application. In this way, in response that the plurality of recommendation configuration items are historical configuration items that have a highest matching probability with the current user in the plurality of historical event configuration items and the plurality of historical indicator configuration items, it may be clearly learned that the recommendation configuration item is from the local indicator library, the from-chart information in the analysis result corresponding to the historical analysis object, or the indicator library of the third-party data management application.

In some embodiments of the present disclosure, it may be supported that a plurality of historical indicator configuration items are only from a target source, where the target source is one of a local indicator library, chart, and a third-party indicator library, and a historical indicator configuration item included in the plurality of recommendation configuration items is also from the target source; or it may be supported that the plurality of historical indicator configuration items are only from a first source and a second source, where the first source is one of the local indicator library, from-chart, and the third-party indicator library, the second source is one of the local indicator library, from-chart, and the third-party indicator library that is different from the first source, and each historical indicator configuration item included in the plurality of recommendation configuration items is from the first source or the second source (that is, the historical indicator configuration items included in the plurality of recommendation configuration items may all be from the first source, or all be from the second source, or some may be from the first source and some may be from the second source); or it may be supported that the plurality of historical indicator configuration items are from the local indicator library, chart, and the third-party indicator library, and each historical indicator configuration item included in the plurality of recommendation configuration items is from the local indicator library, chart, or the third-party indicator library (that is, the historical indicator configuration items included in the plurality of recommendation configuration items may all be from the local indicator library; or all be from chart; or all be from the third-party indicator library; or some may be from the local indicator library and some may be from chart; or some may be from the local indicator library and some may be from the third-party indicator library; or some may be from chart and some may be from the third-party indicator library; or some may be from the local indicator library, some may be from chart, and some may be from the third-party indicator library).

For example, if a data analysis tool has a function corresponding to the event analysis method provided in embodiments of the present disclosure and also has a data management (buried point data, metadata access, metadata management capability, etc.) function, the plurality of historical indicator configuration items may be from the local indicator library and the chart of the data analysis tool.

For example, if a data analysis tool has a function corresponding to the event analysis method provided in embodiments of the present disclosure and does not have a data management (buried point data, metadata access, metadata management capability, etc.) function, and a data management function is provided through a third-party data management application, in response that the third-party data management application does not have an indicator management function, the plurality of historical indicator configuration items may be from the local indicator library and the chart of the data analysis tool; and in response that the third-party data management application also has an indicator management function, the plurality of historical indicator configuration items may be from the local indicator library, the chart, and an indicator library of the third-party data management application of the data analysis tool.

It should be noted that in embodiments of the present disclosure, the indicator library of the third-party data management application is used to define that the third-party data management tool has an indicator management function, and does not define a specific name of a module with the indicator management function in the third-party data management application. For example, the name of the module with the indicator management function in the third-party data management application may also be a scenario library of the third-party data management application.

It should be noted that in response that different users use a data analysis tool or in response that a same user uses the data analysis tool at different times, the plurality of recommendation configuration items described above may be different, and sources of each recommendation configuration item may also be different. The plurality of recommendation configuration items may all be from any one of the event library, the local indicator library, the chart, and the indicator library of the third-party data management application, or the plurality of recommendation configuration items may be respectively from at least two of the event library, the local indicator library, the chart, and the indicator library of the third-party data management application, which may be specifically determined according to an actual situation, and is not limited herein.

In embodiments of the present disclosure, in the initial recommendation scenario and the search recommendation scenario, in addition to the historical indicator configuration items in the local indicator library, the plurality of historical indicator configuration items further include the historical indicator configuration items from the chart and the historical indicator configuration items from the indicator library of the third-party data management application. In this way, these analysis ideas originally scattered in past analysis results of users are converted into historical configuration items to be recommended, which greatly improves rapid transmission and reuse of analysis ideas among users in the same project, and forms a Matthew effect through mutual calling to achieve mutual verification, thereby improving the unity and accuracy of the overall analysis of the users.

In embodiments of the present disclosure, for the search recommendation scenario, in the related art before the method for configuration analysis provided in the present disclosure, before using the search function, the user generally needs to clearly know whether the analysis object is classified under the event tag or the indicator tag, and the search is a simple “character matching” (that is, only an option matching the search keyword in a text description of a historical event configuration item or a historical indicator configuration item is presented to the user as a search result). Therefore, if the user does not have sufficient understanding of the option of the historical event configuration item or the historical indicator configuration item, the user usually cannot clearly know whether the analysis object is classified under the event tag or the indicator tag, and/or the search keyword is often not accurate enough to match an accurate analysis object.

In embodiments of the present disclosure, by using the capability of an artificial intelligence (AI) algorithm to summarize information, expanding a search range, and making overall and efficient use of analysis knowledge scattered everywhere, all historical event configuration items and historical indicator configuration items are included in the search range, the user does not need to know in advance under which tag classification the search target (the object to be analyzed) of the user is, and the historical indicator configuration items from the chart (historical indicator configuration items not entered into the indicator library) are included in the search range, which greatly expands the search range and the efficient reuse of analysis results of other users in the same project, and gives full play to the value of the past charts; and the historical indicator configuration items in the indicator library of the third-party data management application are also included in the search range, which greatly expands the search range and improves the recommendation probability that the user selects a recommendation configuration item.

In some embodiments of the present disclosure, before step 102, the method for configuration analysis provided in embodiments of the present disclosure may further include the following step 104.
104: Present, in response to a trigger operation on the target recommendation configuration item, a configuration details panel corresponding to the target recommendation configuration item, where configuration information of a target analysis object indicated by the target recommendation configuration item is presented in the configuration details panel.

For example, the trigger operation on the target recommendation configuration item may be to present the configuration details panel on the right side of the recommendation configuration panel in response that the mouse hovers over the target recommendation configuration item.

In embodiments of the present disclosure, the user often cannot accurately determine whether the target analysis object indicated by the target recommendation configuration item is the analysis object required by the user based only on the target recommendation configuration item (the name of the target configuration item). Therefore, the configuration details panel corresponding to the target recommendation configuration item is presented in response to the trigger operation on the target recommendation configuration item, and the configuration information of the target analysis object indicated by the target recommendation configuration item is presented in the configuration details panel, which may assist the user in identifying and determining which recommendation configuration item to select.

It should be noted that the above step 104 may support the historical event configuration item from the event library, the historical indicator configuration item from the local indicator library, the historical indicator configuration item from the chart, and the historical indicator configuration item from the indicator library of the third-party data management application.

In some embodiments of the present disclosure, in response that the target recommendation configuration item is a historical event configuration item, the configuration information of the target analysis object includes an event identification, event description information, and event data quality information of an event of the target analysis object. In this way, it may assist the user in identifying and determining which recommendation configuration item to select.

The event identification may be an event name or other identification information, which is not limited herein.

The event description information may include some or all of a buried point position, a trigger description, and a buried point description.

The event data quality information may include some or all of the number of queries within a predetermined duration (the number of times that the user queries the event of the target analysis object within the predetermined duration), the number of query users within the predetermined duration (the number of users who query the event of the target analysis object within the predetermined duration), the number n of charts in use within the predetermined duration (n is a natural number, the number of charts that use the event of the target analysis object within the predetermined duration), the number of items entered into the library yesterday, and the like, which may be specifically determined according to an actual situation, and is not limited herein. The predetermined duration may be determined according to an actual situation, and is not limited herein.

In some embodiments of the present disclosure, in response that the target recommendation configuration item is a historical indicator configuration item and the source of the target recommendation configuration item is the local indicator library or the indicator library of the third-party data management application, the configuration information of the target analysis object includes an indicator meaning, indicator details information, and indicator data quality information of an indicator of the target analysis object. In this way, it may assist the user in identifying and determining which recommendation configuration item to select.

The indicator details information includes details information of an event, details information of a calculation manner, and details information of a filtering condition included in the indicator, which may improve the accuracy of the user in selecting the indicator.

The indicator meaning is determined according to a specific situation, and is not limited herein.

The indicator data quality information may include the number m of charts in use within the predetermined duration (m is a natural number, the number of charts that use the indicator of the target analysis object within the predetermined duration), and the like.

In some embodiments of the present disclosure, in response that the target recommendation configuration item is a historical indicator configuration item and the source of the target recommendation configuration item is the chart information in the analysis result corresponding to a corresponding historical analysis object, the configuration information of the target analysis object includes indicator details information of an indicator of the target analysis object, a chart identification of a target chart to which the indicator belongs, and a dashboard identification of a target dashboard to which the target chart belongs; where the target dashboard is used to present a chart in an analysis result corresponding to at least one historical analysis object. In this way, it may assist the user in identifying and determining which recommendation configuration item to select.

The indicator details information includes details information of an event, a calculation manner, and a filtering condition included in the indicator, which may improve the accuracy of the user in selecting the indicator. The indicator details information is necessary information for the user to determine which recommendation configuration item to select.

The chart identification may be a chart name or other identification information, which is not limited herein.

The dashboard identification may be a dashboard name or other identification information, which is not limited herein. One dashboard is used to present at least one chart.

In embodiments of the present disclosure, the user may determine a correlation degree between the target recommendation configuration item and the analysis object required by the user based on the chart identification of the target chart to which the indicator of the target analysis object belongs and the dashboard identification of the target dashboard to which the target chart belongs, and then determine whether the target recommendation configuration item is a historical indicator configuration item that meets the requirements of the user.

In some embodiments of the present disclosure, in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate.

In embodiments of the present disclosure, if the user has doubts about the accuracy of the buried point corresponding to the event of the target analysis object indicated by the target recommendation configuration item, the user may trigger to go to the corresponding function to verify whether the data recently reported by the buried point corresponding to the event of the target analysis object is accurate through a trigger operation on the buried point real-time verification control.

In some embodiments of the present disclosure, the configuration details panel further presents a configurator identification corresponding to the target recommendation configuration item, and the configurator identification is used to call a target instant messaging application to create a chat window between the current user and a user indicated by the configurator identification.

In response that the target recommendation configuration item is a historical event configuration item, a location where the configurator identification is located includes prompt information of “consult a registrant”, and in response that the target recommendation configuration item is a historical indicator configuration item, a location where the configurator identification is located includes prompt information of “consult a creator”. Other prompt information may also be included, which is not limited herein.

In embodiments of the present disclosure, in response that the target recommendation configuration item is a historical event configuration item, if the configuration information of the target analysis object and the buried point real-time verification control still cannot help the user to dispel the doubts about selection, a chat (a chat window corresponding to the target instant messaging application) of an office software may be initiated through the configurator identification, and a fallback policy of manual inquiry is enabled.

In embodiments of the present disclosure, in response that the target recommendation configuration item is a historical indicator configuration item (including any one of the local indicator library, the chart, and the indicator library of the third-party data management application), if the configuration information of the target analysis object still cannot help the user to dispel the doubts about selection, the chat (the chat window corresponding to the target instant messaging application) of the office software may be initiated through the configurator identification, and the fallback policy of manual inquiry is enabled.

In some embodiments of the present disclosure, in response that the target recommendation configuration item is a historical indicator configuration item and the source of the target recommendation configuration item is the chart information in the analysis result corresponding to the corresponding historical analysis object, the name of the target recommendation configuration item is generated based on the chart identification and the indicator details information. In this way, it may be determined from which chart the target recommendation configuration item comes and information of the indicator of the target analysis object indicated by the target recommendation configuration item, thereby facilitating the user to determine whether the target recommendation configuration item is a historical indicator configuration item that meets the requirements of the user.

In some embodiments of the present disclosure, the configuration details panel may further present a most recent modification time, a creation time, a source identification, of the target recommendation configuration item and the like, which may be specifically determined according to an actual situation and is not limited herein.

In some embodiments of the present disclosure, the configuration details panel may further present a more details control, and a trigger operation on the more details control may trigger to present more details information corresponding to the target recommendation configuration item, which may be specifically determined according to an actual situation and is not limited herein.

In embodiments of the present disclosure, the historical event configuration item includes only configuration information corresponding to an event, and the historical indicator configuration item includes an event and a calculation condition (a calculation manner, or the calculation manner and at least one filtering condition). Therefore, if the target recommendation configuration item selected by the user is the historical indicator configuration item, usually, the target recommendation configuration item has already included a calculation condition, and the user does not need to configure the calculation condition by himself/herself, thereby greatly improving the efficiency of indicator configuration.

In embodiments of the present disclosure, if the target recommendation configuration item selected by the user is the historical event configuration item, the user still needs to configure the calculation condition by himself/herself. Or if the user manually configures the event setting item, the user also needs to configure the calculation condition by himself/herself.

Each filtering condition includes an attribute, a calculation manner, and an attribute value. In a real business scenario, an event often needs to be matched with a plurality of filtering conditions, and there are complex combinations of AND, OR, and AND/OR among the conditions, so that it is time-consuming, difficult, and inaccurate for the user to manually configure the filtering conditions.

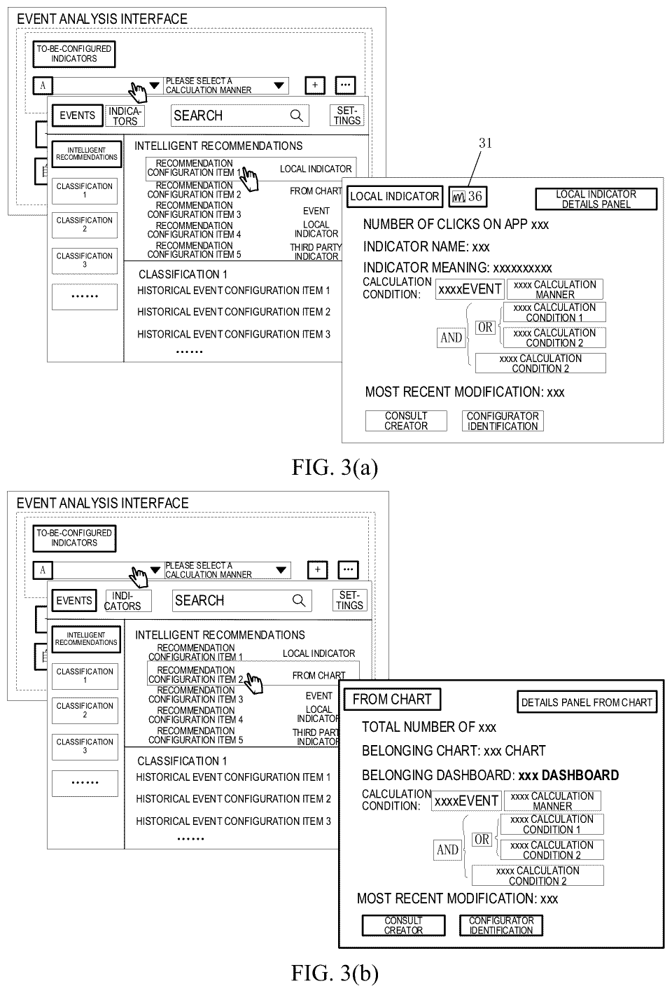

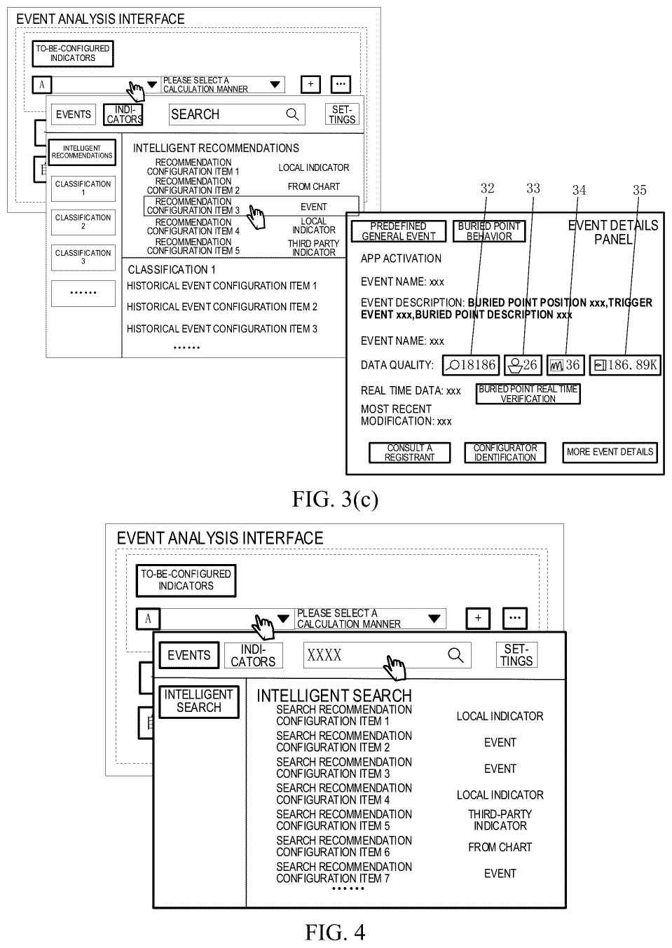

For example, as shown in FIG. 3(a) to FIG. 3(c), a configuration details panel of a local indicator, a configuration details panel from a chart, and a configuration details panel of an event are respectively shown, where a reference numeral “31” indicates that the indicator is used by 36 charts, a reference numeral “32” indicates the number of queries within the past 30 days, a reference numeral “33” indicates the number of query users within the past 30 days, a reference numeral “34” indicates that the indicator is used by 36 charts, and a reference numeral “35” indicates the number of items entered into the library yesterday.

For example, as shown in FIG. 4, a configuration recommendation panel corresponding to a search recommendation scenario is shown, where a search recommendation configuration item corresponds to a recommendation configuration item in the search recommendation scenario.

In some embodiments of the present disclosure, the method for configuration analysis provided in embodiments of the present disclosure may further include the following steps 105 to 106.
105: Present a target event in the event setting item and, in response that no calculation condition is presented in the calculation condition setting item, present an indicator recommendation panel in response to a trigger operation on the to-be-configured indicator entry.

The indicator recommendation panel includes a plurality of recommendation indicator items, and each recommendation indicator item is used to indicate an indicator including the target event.

The target event may be from a historical event configuration item in the plurality of recommendation configuration items (the target recommendation configuration item is a historical event configuration item), or may be from one of a plurality of historical event configuration items selected by the user from the plurality of historical event configuration items classified under the event tag, or may be from one historical event configuration item selected by the user from search results through search, or may be from a historical event configuration item manually configured by the user, which may be specifically determined according to an actual situation, and is not limited herein.

In embodiments of the present disclosure, a specific manifestation of the trigger operation on the to-be-configured indicator entry for presenting the indicator recommendation panel is not limited. For example, the indicator recommendation panel is presented in response to an operation of hovering a mouse over the event setting item, or the indicator recommendation panel is presented in response to an operation of hovering a mouse over the calculation condition setting item, or the indicator recommendation panel is presented in response to an operation of clicking the calculation condition setting item, or the indicator recommendation panel is presented in response to an operation of clicking the event setting item, or the indicator recommendation panel may be presented through another operation triggered. The specific manifestation may be specifically determined according to an actual situation and is not limited herein.
106: Present, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

In embodiments of the present disclosure, after the target event is set in the event setting item, the indicator recommendation panel including the plurality of recommendation indicator items may be presented in response to the trigger operation on the to-be-configured indicator entry. In this way, the user may quickly select the target recommendation indicator item that meets the requirements of the user from the plurality of recommendation indicator items to configure the calculation condition setting item, thereby helping the user quickly configure the filtering condition, greatly reducing the user's pressure of configuring the filtering condition, and also ensuring better accuracy of the configured filtering condition.

In some embodiments of the present disclosure, the indicator recommendation panel further presents a source identification of each recommendation indicator item, and a source identification of a recommendation indicator item includes any one of the following: a local indicator identification, a from-chart identification, and a third-party indicator identification; where the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application.

In embodiments of the present disclosure, the historical indicator configuration items including the historical indicator configuration items from the local indicator library, the historical indicator configuration items from the chart, and the historical indicator configuration items from the indicator library of the third-party data management application are all included in the search range, and the historical indicator configuration items including the target event are searched from the search range to be used as the recommendation indicator items, which expands the search range and may improve the probability of the user to adopt the recommendation indicator items.

In some embodiments of the present disclosure, the plurality of recommendation indicator items are historical indicator configuration items including the target event in the plurality of historical indicator configuration items. Therefore, respective sources corresponding to the plurality of recommendation indicator configuration items are determined by the respective sources corresponding to the plurality of historical indicator configuration items. Specifically, for the respective sources corresponding to the plurality of historical indicator configuration items, reference may be made to the above related descriptions, which is not limited herein.

It should be noted that in response that different users use a data analysis tool or in response that a same user uses the data analysis tool at different times, the plurality of recommendation indicator items described above may be different, and sources of each recommendation indicator item may also be different or the same. The plurality of recommendation indicator items may all be from any one of the local indicator library, the chart, and the indicator library of the third-party data management application, or the plurality of recommendation indicator items may be respectively from at least two of the local indicator library, the chart, and the indicator library of the third-party data management application, which may be specifically determined according to an actual situation, and is not limited herein.

In some embodiments of the present disclosure, the plurality of recommendation indicator items are arranged in a descending order according to corresponding recommendation indices, where the recommendation index of the recommendation indicator is obtained through comprehensive evaluation based on historical query information of a corresponding recommendation indicator, and the historical query information includes at least one of the following: a number of historical queries, a number of people conducting historical queries and a historical query record. In this way, the user may be assisted in determining which recommendation configuration item to select, thereby improving the efficiency of the user in selecting the recommendation configuration item that meets the requirements of the user.

In some embodiments of the present disclosure, after step 105, the method for configuration analysis provided in embodiments of the present disclosure may further include the following step 107.
107: Present, in response to a trigger operation on the target recommendation indicator item, an indicator details panel corresponding to the target recommendation indicator item, where configuration information of a target analysis object indicated by the target recommendation indicator item is presented in the indicator details panel.

In some embodiments of the present disclosure, in response that the target recommendation indicator item is a historical indicator configuration item and the source of the target recommendation indicator item is the local indicator library or the indicator library of the third-party data management application, the configuration information of the target analysis object includes an indicator meaning, indicator details information, and indicator data quality information of an indicator of the target analysis object.

In some embodiments of the present disclosure, in response that the target recommendation indicator item is a historical indicator configuration item and the source of the target recommendation indicator item is the chart information in the analysis result corresponding to a corresponding historical analysis object, the configuration information of the target analysis object includes indicator details information of an indicator of the target analysis object, a chart identification of a target chart to which the indicator belongs, and a dashboard identification of a target dashboard to which the target chart belongs; where the target dashboard is used to present a chart in an analysis result corresponding to at least one historical analysis object.

In some embodiments of the present disclosure, the indicator details panel further presents a configurator identification corresponding to the target recommendation indicator item, and the configurator identification is used to call a target instant messaging application to create a chat window between the current user and a user indicated by the configurator identification.

In some embodiments of the present disclosure, in response that the target recommendation indicator item is a historical indicator configuration item and the source of the target recommendation indicator item is the chart information in the analysis result corresponding to the corresponding historical analysis object, the name of the target recommendation indicator item is generated based on the chart identification and the indicator details information.

It should be noted that the description of the target recommendation indicator item may refer to the related description of the target recommendation configuration item, which will not be repeated herein.

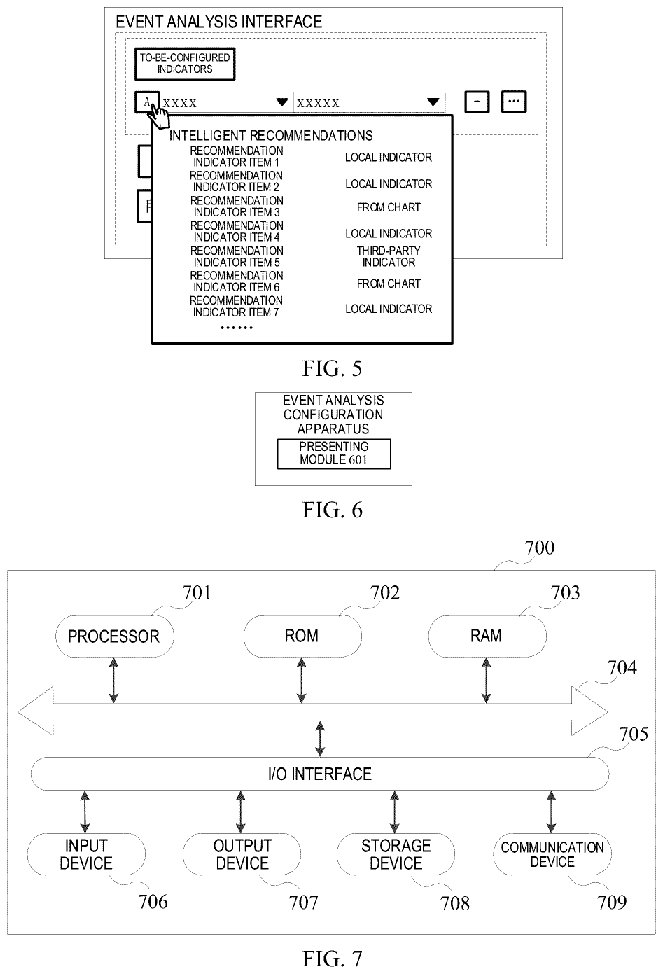

For example, as shown in FIG. 5, a schematic diagram of an indicator recommendation panel corresponding to an indicator recommendation scenario after an event is configured is shown.

In some embodiments of the present disclosure, the method for configuration analysis provided in embodiments of the present disclosure may further include the following step 108.
108: Update a target calculation condition in response to an edit operation on the target calculation condition in response that the target event is presented in the event setting item and the target calculation condition is presented in the calculation condition setting item.

The updating the target calculation manner may include at least one of the following: deleting one or more of the at least one target filtering condition, modifying one or more of the at least one target filtering condition, adding one or more target filtering conditions, and modifying the calculation manner; or may include another update operation, which may be specifically determined according to an actual situation, and is not limited herein.

In embodiments of the present disclosure, in response that the target event is presented in the event setting item and the target calculation condition is presented in the calculation condition setting item, the user may optimize or customize the target calculation condition through the edit operation, so that the analysis object obtained through configuration more meets the requirements of the user.

The intelligent recommendation, intelligent search, and intelligent label recommendation provided in embodiments of the present disclosure are all completely embodied in each step of interaction in which the user configures the analysis. The user does not need to take an additional time, and the cost may be reduced, and efficiency may be improved for the user immediately.

It is indeed fast and reliable to adjust parameters based on the analysis results of others. Therefore, in the recommendation options given in the intelligent recommendation, intelligent search, and intelligent label recommendation, we expand the scope of “analysis results of others”: from a local indicator library, from a chart, and from an indicator library of a third-party data management application, and comprehensively evaluate the “trustworthiness” of these existing analysis results according to dimensions such as “the number of historical queries and the number of query users” (the more the number of historical queries and the number of query users, the more people have verified the accuracy of the existing analysis results).

With the above wider range and more reliable recommendations, there will be fewer and fewer cases that need to be inquired offline. At the same time, the information of the registrant/creator corresponding to each option is also marked in the details panel. If the user still has doubts about the option, the user may more accurately and conveniently find the corresponding person to inquire.

The cost of data governance and the difficulty of actual implementation are already industry consensus in many data products. It is very important but difficult to do well. In the rapid development of the business, there are often no resources invested; and in our intelligent recommendation system, high-quality data is recommended every time the user uses data in daily life, so that more accurate data is reused by more people, and worse data is less misled by people, which greatly accelerates the classification of data quality and also reduces the difficulty of data governance.

FIG. 6 is a block diagram of a structure of an apparatus for configuration analysis according to an embodiment of the present disclosure. As shown in FIG. 6, the apparatus includes: a presenting module 601, configured to present an event analysis interface, where the event analysis interface includes a to-be-configured indicator entry, the to-be-configured indicator entry being configured to configure an object to be analyzed, the to-be-configured indicator entry includes an event setting item and a calculation condition setting item, where the event setting item is configured to set an event of the object to be analyzed, the calculation condition setting item is configured to set a calculation condition of the object to be analyzed, the calculation condition including a calculation manner, or the calculation condition including the calculation manner and at least one filtering condition;
present, in response to a target trigger operation, a configuration recommendation panel corresponding to the to-be-configured indicator entry, where a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and
present, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

In some embodiments of the present disclosure, the plurality of recommendation configuration items include at least one of the following: at least one historical event configuration item and at least one historical indicator configuration item; the configuration recommendation panel further includes an event tag and an indicator tag, and in response that the event tag is in a selected state, the configuration recommendation panel is further configured to present a plurality of historical event configuration items, where the plurality of recommendation configuration items are ranked before the plurality of historical event configuration items, and the at least one historical event configuration item is a part of the plurality of historical event configuration items, where each historical event configuration item is used to indicate event configuration information of a historical analysis object; and in response that the indicator tag is in a selected state, the configuration recommendation panel is further configured to present a plurality of historical indicator configuration items, where the plurality of recommendation configuration items are ranked before the plurality of historical indicator configuration items, and the at least one historical indicator configuration item is a part of the plurality of historical indicator configuration items, where each historical indicator configuration item is used to indicate indicator configuration information of a historical analysis object; where the historical configuration item set includes the plurality of historical event configuration items and the plurality of historical indicator configuration items.

In some embodiments of the present disclosure, the configuration recommendation panel further includes a source identification corresponding to each recommendation configuration item; in response that the recommendation configuration item is a historical event configuration item, the source identification corresponding to the recommendation configuration item is an event identification, and the event identification is used to indicate that the recommendation configuration item is from an event library; or in response that the recommendation configuration item is a historical indicator configuration item, the source identification of the recommendation configuration item includes any one of the following: a local indicator identification, a from-chart identification, and a third-party indicator identification; where the local indicator identification is used to indicate that the recommendation configuration item is from a local indicator library, the from-chart identification is used to indicate that the recommendation configuration item is from chart information in an analysis result corresponding to a historical analysis object, and the third-party indicator identification is used to indicate that the recommendation configuration item is from an indicator library of a third-party data management application.

In some embodiments of the present disclosure, the presenting module 601 is further configured to after presenting, in response to the trigger operation on the to-be-configured indicator entry, present, in response to the trigger operation on the target recommendation configuration item, a configuration details panel corresponding to the target recommendation configuration item, where configuration information of a target analysis object indicated by the target recommendation configuration item is presented in the configuration details panel; in response that the target recommendation configuration item is a historical indicator configuration item, and a source of the target recommendation configuration item is a local indicator library or an indicator library of a third-party data management application, the configuration information of the target analysis object includes an indicator meaning, indicator details information, and indicator data quality information of an indicator of the target analysis object; in response that the target recommendation configuration item is a historical indicator configuration item, and a source of the target recommendation configuration item is chart information in an analysis result corresponding to a corresponding historical analysis object, the configuration information of the target analysis object includes indicator details information of an indicator of the target analysis object, a chart identification of a target chart to which the indicator belongs, and a dashboard identification of a target dashboard to which the target chart belongs, where the target dashboard is used to present a chart in an analysis result corresponding to at least one historical analysis object.

In some embodiments of the present disclosure, in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate; and/or a configurator identification corresponding to the target recommendation configuration item is further presented in the configuration details panel, and the configurator identification is used to call a target instant messaging application and create a chat window between the current user and a user indicated by the configurator identification; and/or in response that the target recommendation configuration item is a historical indicator configuration item, and a source of the target recommendation configuration item is chart information in an analysis result corresponding to a corresponding historical analysis object, a name of the target recommendation configuration item is generated based on the chart identification and the indicator details information.

In some embodiments of the present disclosure, the presenting module 601 is further configured to in response that a target event is presented in the event setting item and no calculation condition is presented in the calculation condition setting item, present an indicator recommendation panel in response to a trigger operation on the to-be-configured indicator entry, where the indicator recommendation panel includes a plurality of recommendation indicator items, and each recommendation indicator item is used to indicate an indicator including the target event; and present, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

In some embodiments of the present disclosure, the indicator recommendation panel further presents a source identification of each recommendation indicator item, and the source identification of the recommendation indicator item includes any one of the following: a local indicator identification, a from-chart identification, and a third-party indicator identification; where the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application; and/or the plurality of recommendation indicator items are arranged in a descending order according to corresponding recommendation indices, where the recommendation index of the recommendation indicator is obtained through comprehensive evaluation based on historical query information of a corresponding recommendation indicator, and the historical query information includes at least one of the following: a number of historical queries, a number of people conducting historical queries and a historical query record.

In some embodiments of the present disclosure, the apparatus further includes: an update module, configured to update a target calculation condition in response to an edit operation on the target calculation condition in response that the target event is presented in the event setting item and the target calculation condition is presented in the calculation condition setting item.

In some embodiments of the present disclosure, the target trigger operation includes a first trigger operation on the to-be-configured indicator entry and a search operation on a search control, and the presenting module is specifically configured to: present, in response to the first trigger operation, the configuration recommendation panel including the search control; and present, in response to the search operation, the plurality of recommendation configuration items in the configuration recommendation panel; where the plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

In some embodiments of the present disclosure, configuration information of an analysis object indicated by each search configuration item includes the search keyword, and/or configuration information of an analysis object indicated by each search configuration item includes information representing a generalized meaning of the search keyword.

In embodiments of the present disclosure, each module may implement the method for configuration analysis provided in the above method embodiments, and may achieve the same technical effect. To avoid repetition, details are not described herein again.

FIG. 7 is a schematic diagram of a structure of an electronic device according to an embodiment of the present disclosure, which is used to illustrate the electronic device that implements any method for configuration analysis in embodiments of the present disclosure, and should not be construed as a specific limitation to the embodiments of the present disclosure.

As shown in FIG. 7, the electronic device 700 may include a processor (e.g., a central processing unit, a graphics processing unit, etc.) 701 that may perform a variety of appropriate actions and processing in accordance with a program stored in a read-only memory (ROM) 702 or a program loaded from a storage device 708 into a random access memory (RAM) 703. The RAM 703 further stores various programs and data required for the operation of the electronic device 700. The processor 701, the ROM 702, and the RAM 703 are connected to each other through a bus 704. An input/output (I/O) interface 705 is also connected to the bus 704.

Generally, the following apparatuses may be connected to the I/O interface 705: an input device 706 including, for example, a touchscreen, a touchpad, a keyboard, a mouse, a camera, a microphone, an accelerometer, a gyroscope, etc.; an output device 707 including, for example, a liquid crystal display (LCD), a speaker, a vibrator, etc.; the storage device 708 including, for example, a tape, a hard disk, etc.; and a communication device 709. The communication device 709 may allow the electronic device 700 to perform wireless or wired communication with other devices to exchange data. Although the electronic device 700 having various apparatuses is shown, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, an embodiment of the present disclosure includes a computer program product, which includes a computer program carried on a non-transitory computer-readable medium, where the computer program includes program code for performing the method shown in the flowcharts. In such an embodiment, the computer program may be downloaded and installed from a network through the communication device 709, or installed from the storage device 708, or installed from the ROM 702. When the computer program is executed by the processor 701, the functions defined in any of the methods for configuration analysis provided in embodiments of the present disclosure may be performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a HyperText Transfer Protocol (HTTP), and may be connected to digital data communication (e.g., a communication network) in any form or medium. Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be contained in the above electronic device; or may exist independently, without being assembled into the electronic device.

The above computer-readable medium carries one or more programs which, in response that executed by the electronic device, cause the electronic device to: present an event analysis interface, where the event analysis interface includes a to-be-configured indicator entry, the to-be-configured indicator entry is configured to configure an object to be analyzed, the to-be-configured indicator entry includes an event setting item and a calculation condition setting item, the event setting item is configured to set an event of the object to be analyzed, the calculation condition setting item is configured to set a calculation condition of the object to be analyzed, the calculation condition includes a calculation manner, or the calculation condition includes the calculation manner and at least one filtering condition; present a configuration recommendation panel corresponding to the to-be-configured indicator entry in response to a target trigger operation, where a plurality of recommendation configuration items are presented in the configuration recommendation panel, the plurality of recommendation configuration items are historical configuration items with a highest matching probability with a current user in a historical configuration item set, and each historical configuration item is used to indicate configuration information of a historical analysis object; and present, in the to-be-configured indicator entry, target configuration information corresponding to a target recommendation configuration item in the plurality of recommendation configuration items in response to a trigger operation on the target recommendation configuration item, so as to obtain corresponding buried point data from a database corresponding to the object to be analyzed based on the target configuration information, and perform event analysis on the object to be analyzed to obtain an analysis result. In embodiments of the present disclosure, the computer program code for performing the operations of the present disclosure may be written in one or more programming languages or a combination thereof, where the programming languages include an object-oriented programming language such as Java, Smalltalk, and C++, and further include conventional procedural programming languages such as “C” language or similar programming languages. The program code may be completely executed on a computer, partially executed on a computer, executed as an independent software package, partially executed on a computer and partially executed on a remote computer, or completely executed on a remote computer or server. In the case involving a remote computer, the remote computer may be connected to a computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in embodiments of the present disclosure may be implemented by means of software, or may be implemented by means of hardware. The name of a unit does not constitute a limitation on the unit itself in some cases.

The functions described herein above may be performed, at least in part, by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a computer-readable medium may be a tangible medium that may contain or store a program used by or in combination with an instruction execution system, apparatus, or device. The computer-readable medium may be a computer-readable signal medium or a computer-readable storage medium. The computer-readable medium may include, but is not limited to, electronic, magnetic, optical, electromagnetic, infrared, or semiconductor systems, apparatuses, or devices, or any suitable combination thereof. A more specific example of a computer-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above descriptions are merely preferred embodiments of the present disclosure and illustrations of the applied technical principles. Persons skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above concept of disclosure. For example, a technical solution formed by replacing the above features with technical features having similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the above discussions, these details should not be construed as limiting the scope of the present disclosure. Some features that are described in the context of separate embodiments may alternatively be implemented in combination in a single embodiment. In contrast, various features described in the context of a single embodiment may alternatively be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for configuration analysis, comprising:
presenting an event analysis interface, wherein the event analysis interface comprises a to-be-configured indicator entry, the to-be-configured indicator entry configured to configure an object to be analyzed, and the to-be-configured indicator entry comprises an event setting item and a calculation condition setting item; wherein the event setting item is configured to set an event of the object to be analyzed, and the calculation condition setting item is configured to set a calculation condition of the object to be analyzed, the calculation condition comprising a calculation manner, or the calculation condition comprising the calculation manner and at least one filtering condition;
presenting, in response to a target trigger operation, a configuration recommendation panel corresponding to the to-be-configured indicator entry, wherein a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and
presenting, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

2. The method of claim 1, wherein the plurality of recommendation configuration items comprise at least one of the following: at least one historical event configuration item and at least one historical indicator configuration item;
the configuration recommendation panel further comprises an event tag and an indicator tag, and in response that the event tag is in a selected state, the configuration recommendation panel is further configured to present a plurality of historical event configuration items, wherein the plurality of recommendation configuration items are ranked before the plurality of historical event configuration items, and the at least one historical event configuration item is a part of the plurality of historical event configuration items, wherein each historical event configuration item is used to indicate event configuration information of a historical analysis object; and
in response that the indicator tag is in a selected state, the configuration recommendation panel is further configured to present a plurality of historical indicator configuration items, wherein the plurality of recommendation configuration items are ranked before the plurality of historical indicator configuration items, and the at least one historical indicator configuration item is a part of the plurality of historical indicator configuration items, wherein each historical indicator configuration item is used to indicate indicator configuration information of a historical analysis object;
wherein the historical configuration item set comprises the plurality of historical event configuration items and the plurality of historical indicator configuration items.

3. The method of claim 2, wherein the configuration recommendation panel further comprises a source identification corresponding to each recommendation configuration item;
in response that the recommendation configuration item is a historical event configuration item, the source identification corresponding to the recommendation configuration item is an event identification, and the event identification is used to indicate that the recommendation configuration item is from an event library; or
in response that the recommendation configuration item is a historical indicator configuration item, the source identification of the recommendation configuration item comprises any one of the following: a local indicator identification, a from-chart identification, and a third-party indicator identification; wherein the local indicator identification is used to indicate that the recommendation configuration item is from a local indicator library, the from-chart identification is used to indicate that the recommendation configuration item is from chart information in an analysis result corresponding to a historical analysis object, and the third-party indicator identification is used to indicate that the recommendation configuration item is from an indicator library of a third-party data management application.

4. The method of claim 2, wherein after presenting, in response to the trigger operation on the to-be-configured indicator entry, the configuration recommendation panel, the method further comprises:
presenting, in response to the trigger operation on the target recommendation configuration item, a configuration details panel corresponding to the target recommendation configuration item, wherein configuration information of a target analysis object indicated by the target recommendation configuration item is presented in the configuration details panel;
in response that the target recommendation configuration item is a historical event configuration item, the configuration information of the target analysis object comprises an event identification, event description information, and event data quality information of an event of the target analysis object;
in response that the target recommendation configuration item is a historical indicator configuration item, and a source of the target recommendation configuration item is a local indicator library or an indicator library of a third-party data management application, the configuration information of the target analysis object comprises an indicator meaning, indicator details information, and indicator data quality information of an indicator of the target analysis object; or
in response that the target recommendation configuration item is a historical indicator configuration item, and a source of the target recommendation configuration item is chart information in an analysis result corresponding to a corresponding historical analysis object, the configuration information of the target analysis object comprises indicator details information of an indicator of the target analysis object, a chart identification of a target chart to which the indicator belongs, and a dashboard identification of a target dashboard to which the target chart belongs, wherein the target dashboard is used to present a chart in an analysis result corresponding to at least one historical analysis object.

5. The method of claim 4, wherein in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate; and/or
a configurator identification corresponding to the target recommendation configuration item is further presented in the configuration details panel, and the configurator identification is used to call a target instant messaging application and create a chat window between the current user and a user indicated by the configurator identification; and/or
in response that the target recommendation configuration item is a historical indicator configuration item, and a source of the target recommendation configuration item is chart information in an analysis result corresponding to a corresponding historical analysis object, a name of the target recommendation configuration item is generated based on the chart identification and the indicator details information.

6. The method of claim 1, further comprising:
in response that a target event is presented in the event setting item and no calculation condition is presented in the calculation condition setting item, presenting an indicator recommendation panel in response to a trigger operation on the to-be-configured indicator entry, wherein the indicator recommendation panel comprises a plurality of recommendation indicator items, and each recommendation indicator item is used to indicate an indicator comprising the target event; and
presenting, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

7. The method of claim 6, wherein the indicator recommendation panel further presents a source identification of each recommendation indicator item, and the source identification of the recommendation indicator item comprises any one of the following: a local indicator identification, a from-chart identification, and a third-party indicator identification; wherein the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application; and/or
the plurality of recommendation indicator items are arranged in a descending order according to corresponding recommendation indices, wherein the recommendation index of the recommendation indicator is obtained through comprehensive evaluation based on historical query information of a corresponding recommendation indicator, and the historical query information comprises at least one of the following: a number of historical queries, a number of people conducting historical queries and a historical query record.

8. The method of claim 1, further comprising:
updating a target calculation condition in response to an edit operation on the target calculation condition in response that the target event is presented in the event setting item and the target calculation condition is presented in the calculation condition setting item.

9. The method of claim 1, wherein the target trigger operation comprises a first trigger operation on the to-be-configured indicator entry and a search operation on a search control, and presenting, in response to the target trigger operation, the configuration recommendation panel corresponding to the to-be-configured indicator entry comprises:
presenting, in response to the first trigger operation, the configuration recommendation panel comprising the search control; and
presenting, in response to the search operation, the plurality of recommendation configuration items in the configuration recommendation panel;
wherein the plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

10. The method of claim 9, wherein configuration information of an analysis object indicated by each search configuration item comprises the search keyword, and/or configuration information of an analysis object indicated by each search configuration item comprises information representing a generalized meaning of the search keyword.

11. An electronic device, comprising: a memory and a processor, the memory storing a computer program, the computer program, when called by the processor, performs acts comprising:
presenting an event analysis interface, wherein the event analysis interface comprises a to-be-configured indicator entry, the to-be-configured indicator entry configured to configure an object to be analyzed, and the to-be-configured indicator entry comprises an event setting item and a calculation condition setting item; wherein the event setting item is configured to set an event of the object to be analyzed, and the calculation condition setting item is configured to set a calculation condition of the object to be analyzed, the calculation condition comprising a calculation manner, or the calculation condition comprising the calculation manner and at least one filtering condition;
presenting, in response to a target trigger operation, a configuration recommendation panel corresponding to the to-be-configured indicator entry, wherein a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and
presenting, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.

12. The electronic device of claim 11, wherein the plurality of recommendation configuration items comprise at least one of the following: at least one historical event configuration item and at least one historical indicator configuration item;
the configuration recommendation panel further comprises an event tag and an indicator tag, and in response that the event tag is in a selected state, the configuration recommendation panel is further configured to present a plurality of historical event configuration items, wherein the plurality of recommendation configuration items are ranked before the plurality of historical event configuration items, and the at least one historical event configuration item is a part of the plurality of historical event configuration items, wherein each historical event configuration item is used to indicate event configuration information of a historical analysis object; and
in response that the indicator tag is in a selected state, the configuration recommendation panel is further configured to present a plurality of historical indicator configuration items, wherein the plurality of recommendation configuration items are ranked before the plurality of historical indicator configuration items, and the at least one historical indicator configuration item is a part of the plurality of historical indicator configuration items, wherein each historical indicator configuration item is used to indicate indicator configuration information of a historical analysis object;
wherein the historical configuration item set comprises the plurality of historical event configuration items and the plurality of historical indicator configuration items.

13. The electronic device of claim 12, wherein the configuration recommendation panel further comprises a source identification corresponding to each recommendation configuration item;
in response that the recommendation configuration item is a historical event configuration item, the source identification corresponding to the recommendation configuration item is an event identification, and the event identification is used to indicate that the recommendation configuration item is from an event library; or
in response that the recommendation configuration item is a historical indicator configuration item, the source identification of the recommendation configuration item comprises any one of the following: a local indicator identification, a from-chart identification, and a third-party indicator identification; wherein the local indicator identification is used to indicate that the recommendation configuration item is from a local indicator library, the from-chart identification is used to indicate that the recommendation configuration item is from chart information in an analysis result corresponding to a historical analysis object, and the third-party indicator identification is used to indicate that the recommendation configuration item is from an indicator library of a third-party data management application.

14. The electronic device of claim 12, wherein after presenting, in response to the trigger operation on the to-be-configured indicator entry, the configuration recommendation panel, the acts further comprise:
presenting, in response to the trigger operation on the target recommendation configuration item, a configuration details panel corresponding to the target recommendation configuration item, wherein configuration information of a target analysis object indicated by the target recommendation configuration item is presented in the configuration details panel;
in response that the target recommendation configuration item is a historical event configuration item, the configuration information of the target analysis object comprises an event identification, event description information, and event data quality information of an event of the target analysis object;
in response that the target recommendation configuration item is a historical indicator configuration item, and a source of the target recommendation configuration item is a local indicator library or an indicator library of a third-party data management application, the configuration information of the target analysis object comprises an indicator meaning, indicator details information, and indicator data quality information of an indicator of the target analysis object; or
in response that the target recommendation configuration item is a historical indicator configuration item, and a source of the target recommendation configuration item is chart information in an analysis result corresponding to a corresponding historical analysis object, the configuration information of the target analysis object comprises indicator details information of an indicator of the target analysis object, a chart identification of a target chart to which the indicator belongs, and a dashboard identification of a target dashboard to which the target chart belongs, wherein the target dashboard is used to present a chart in an analysis result corresponding to at least one historical analysis object.

15. The electronic device of claim 14, wherein in response that the target recommendation configuration item is a historical event configuration item, a buried point real-time verification control is further presented in the configuration details panel, and the buried point real-time verification control is used to jump to a corresponding function to verify whether data recently reported by a buried point corresponding to an event of the target analysis object is accurate; and/or
a configurator identification corresponding to the target recommendation configuration item is further presented in the configuration details panel, and the configurator identification is used to call a target instant messaging application and create a chat window between the current user and a user indicated by the configurator identification; and/or
in response that the target recommendation configuration item is a historical indicator configuration item, and a source of the target recommendation configuration item is chart information in an analysis result corresponding to a corresponding historical analysis object, a name of the target recommendation configuration item is generated based on the chart identification and the indicator details information.

16. The electronic device of claim 11, the acts further comprising:
in response that a target event is presented in the event setting item and no calculation condition is presented in the calculation condition setting item, presenting an indicator recommendation panel in response to a trigger operation on the to-be-configured indicator entry, wherein the indicator recommendation panel comprises a plurality of recommendation indicator items, and each recommendation indicator item is used to indicate an indicator comprising the target event; and
presenting, in the calculation condition setting item, a target calculation condition of an indicator indicated by a target recommendation indicator item in response to a trigger operation on the target recommendation indicator item in the plurality of recommendation indicator items, so as to obtain corresponding buried point data from a database corresponding to the object to be analyzed based on the target event and the target calculation condition, and perform event analysis on the object to be analyzed to obtain an analysis result.

17. The electronic device of claim 16, wherein the indicator recommendation panel further presents a source identification of each recommendation indicator item, and the source identification of the recommendation indicator item comprises any one of the following: a local indicator identification, a from-chart identification, and a third-party indicator identification; wherein the local indicator identification is used to indicate that the recommendation indicator item is from a local indicator library, the from-chart identification is used to indicate that the recommendation indicator item is from chart information in an analysis result corresponding to a historical analysis object, and the third-party indicator identification is used to indicate that the recommendation indicator item is from an indicator library of a third-party data management application; and/or
the plurality of recommendation indicator items are arranged in a descending order according to corresponding recommendation indices, wherein the recommendation index of the recommendation indicator is obtained through comprehensive evaluation based on historical query information of a corresponding recommendation indicator, and the historical query information comprises at least one of the following: a number of historical queries, a number of people conducting historical queries and a historical query record.

18. The electronic device of claim 11, the acts further comprising:
updating a target calculation condition in response to an edit operation on the target calculation condition in response that the target event is presented in the event setting item and the target calculation condition is presented in the calculation condition setting item.

19. The electronic device of claim 11, wherein the target trigger operation comprises a first trigger operation on the to-be-configured indicator entry and a search operation on a search control, and presenting, in response to the target trigger operation, the configuration recommendation panel corresponding to the to-be-configured indicator entry comprises:
presenting, in response to the first trigger operation, the configuration recommendation panel comprising the search control; and
presenting, in response to the search operation, the plurality of recommendation configuration items in the configuration recommendation panel;
wherein the plurality of recommendation configuration items are historical configuration items that have a highest matching probability with a current user in a plurality of search configuration items, and the plurality of search configuration items are historical configuration items that are obtained by searching the historical configuration items in the historical configuration item set and that match a search keyword corresponding to the search operation.

20. A non-transitory computer-readable storage medium, having stored thereon a computer program, the computer program, when executed by a processor, implements acts comprising:
presenting an event analysis interface, wherein the event analysis interface comprises a to-be-configured indicator entry, the to-be-configured indicator entry configured to configure an object to be analyzed, and the to-be-configured indicator entry comprises an event setting item and a calculation condition setting item; wherein the event setting item is configured to set an event of the object to be analyzed, and the calculation condition setting item is configured to set a calculation condition of the object to be analyzed, the calculation condition comprising a calculation manner, or the calculation condition comprising the calculation manner and at least one filtering condition;
presenting, in response to a target trigger operation, a configuration recommendation panel corresponding to the to-be-configured indicator entry, wherein a plurality of recommendation configuration items are presented in the configuration recommendation panel, the plurality of recommendation configuration items being historical configuration items that have a highest matching probability with a current user in a historical configuration item set, and each historical configuration item is used to indicate configuration information of a historical analysis object; and
presenting, in the to-be-configured indicator entry, target configuration information corresponding to a target recommendation configuration item in response to a trigger operation on the target recommendation configuration item in the plurality of recommendation configuration items, so as to obtain corresponding buried point data from a database corresponding to the object to be analyzed based on the target configuration information, and perform event analysis on the object to be analyzed to obtain an analysis result.
